(19) United States
(12) Patent Application Publication
(10) Pub. No.: US 2009/0140024 A1
(43) Pub. Date: Jun. 4, 2009

(54) Multi-use cargo carrier adaptor and assemblies including the same

(76) Inventors: Don McLemore, Columbus, GA (US); John McLemore, Fortson, GA (US)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/007,581

(22) Filed: Jan. 11, 2008

Related U.S. Application Data
(63) Continuation of application No. 29/290,394, filed on Nov. 29, 2007.

(51) Int. Cl. B60R 9/06

(52) U.S. Cl. 224/519; 224/495; 29/428

(57) ABSTRACT

A cargo carrier apparatus with cargo platform and vehicle hitch receiver bar. The cargo platform is supported by the receiver bar and the cargo carrier apparatus has an adaptor supported by the receiver bar. The adaptor having an additional component assembly joining device and a sleeve portion secured to a free end of the receiver bar with the sleeve being C-shaped cross-sectioned that is supported by an underlying portion of the receiver bar. The adaptor having a joining device receiving an extension device extending between the joining device and an above supported additional component as in a bike carrier assembly or grill assembly. The cargo platform, adaptor and receiver bar are stacked with one or more bolts extending through all elements in the stack. The extension device includes a straight or bent support post with attachment device at both ends for connection with the joining device and the additional component.

### CROSS REFERENCE TO RELATED APPLICATION(S)

The present application is a continuation of U.S. Design Patent Application No. 29/290,394 filed on Nov. 29, 2007, which application is incorporated herein by reference.

### BACKGROUND

There exists in the prior art a variety of cargo carriers suited for attachment to a hitch provided on a vehicle. These cargo carriers are helpful in expanding the cargo space made available by a vehicle and also provide a convenient location for items not desired for placement within the interior of a vehicle (e.g., a wet bag of bark mulch). The cargo carriers also provide a convenient location for storage of recreation equipment as in coolers and grills for use in sporting and non-sporting recreational events such as “tailgate” and camping situations. When the cargo carrier is used to transport a grill to a cooking area, the user removes the grill from the cargo platform and sets it up on its own stand or on a table (if available) sufficiently removed from the vehicle. This usage can be problematic as in the lack of stability associated with many grill structures and in the operator often having to bend over to ground level for cooking, etc.

Also, most vehicles have a single hitch attachment. Thus, the presence of a cargo carrier that is hitch attached precludes the attachment of other vehicle hitch supported items as in bike carriers and the like once the cargo carrier is in position on the vehicle.

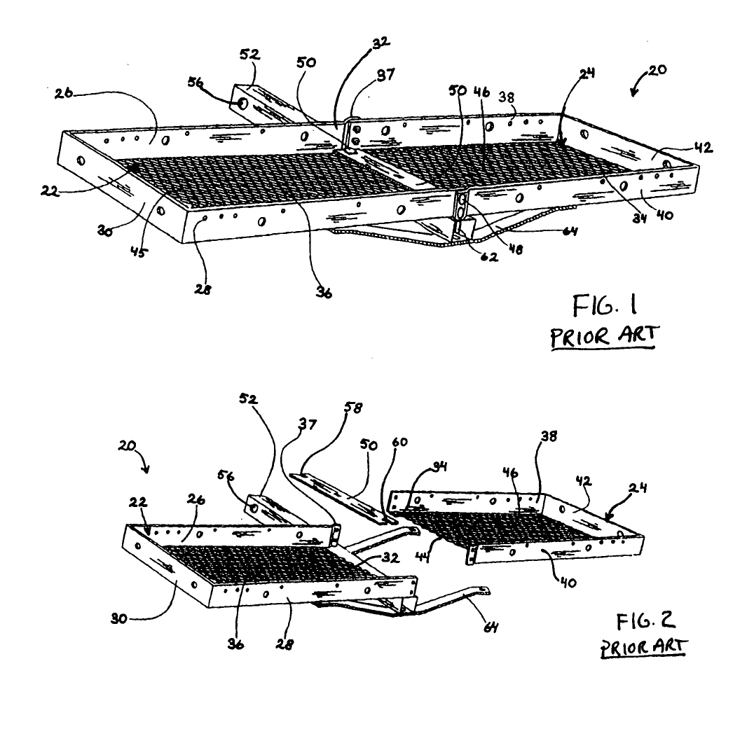

An example of a cargo carrier, selected from the large selection provided in the art, is seen in the prior art FIGS. 1 and 2 of the present application which figures are derived from U.S. RE38,895 to Don McLemore, which reissue patent is incorporated herein by reference. As seen from FIGS. 1 and 2, the preexisting cargo carriers included a cargo carrier 20. The cargo carrier 20 is shown comprised of two individual cargo platform sections 22 and 24. The cargo platform section 22 is shown comprised of interior side wall 26 and exterior side wall 28 joined at one end by end wall 30 and having an open interior end 32 such that platform section 22 has a vertical side wall assembly that is U-shaped. The references made herein to “interior” and “exterior” are made relative to the intended supporting vehicle or, in other words, a component closer to the vehicle back end region will be more interior than a component farther rearward of the vehicle. Also, each side and end wall has a lower edge inwardly extending flange 34 that provides a support region for mesh sheeting 36 (FIG. 2). Cargo platform section 24 has a similar arrangement as that of platform section 22 and is shown comprised of interior side wall 38 and exterior side wall 40 joined at one end by end wall 42 and having an open interior end 44 such that platform section 24 has a U-shaped vertical side wall assembly. Also, each side and end wall of platform section 24 has a lower edge inward flange extension 34 that provides a support region for mesh sheeting 46.

As further shown in FIGS. 1 and 2 the free interior ends of the interior and exterior side walls of platform sections 22 and 24 are secured together to complete cargo platform assembly 47 defining cargo space 45 suited for holding cargo as in coolers and other items that will fit within the support surface area defined by mesh sheeting 36 and 46. In the cargo carrier illustrated in FIGS. 1 and 2, there is an offset nesting arrangement at the noted free ends 37 and the free ends of the respective side walls are secured with short bolts 48 provided at each nesting end. FIGS. 1 and 2 further show tie plate 50 of cargo platform assembly 47 extending parallel to end walls 30 and 42 and in a clamping arrangement over the adjacent free edges of mesh sheeting 36 and 46 and extending essentially fully between the two side wall sets.

FIGS. 1 and 2 also show receiver bar 52 having a hitch connection end 54 with illustrated hitch pin hole set 56 at one end (hole axis extending horizontally) and a set of vertical bolt reception holes (not shown—but are holes with axes extending vertically and positioned at spaced locations on the opposite end region of the receive bar at locations generally assumed by the connection slots 58, 60 at the free ends of tie plate 50).

There is further illustrated individual bridge supports 64, 66 of cargo platform assembly 47 that extend to opposite sides of receiver bar 52 and are connected at their ends to the under side regions of the respective side wall flanges of cargo platform sections 22 and 24. Thus, as shown in FIG. 1, upon extension of the bolts 62 through the respective holes in tie plate 50, and receiver holes in receiver bar 52 and the holes provided in the intermediate region of the bridge supports 64 and 66 there is provided an assembled cargo carrier 20 comprised of cargo platform assembly 47 (with individual bridge supports 64 and 66) and receiver bar 52.

While providing a stable cargo carrier that can be easily assembled and un-assembled as well as easily inserted or removed from a vehicle, as by vehicle hitch pin manipulation, the cargo carrier of FIGS. 1 and 2 suffers from some drawbacks. These drawbacks, which are experienced by other cargo carrier types as well, include the preclusion of usage of other hitch connecting components at the same time and the lack of a good support base for attachment of other articles as in recreation related devices such as a grill or bike rack.

### SUMMARY OF THE INVENTION

The present invention is directed at providing a more versatile cargo carrier apparatus such as one that enables the easy attachment of an additional component (relative to the cargo carrier assembly) and also a switching out amongst a plurality of additional component choices. This versatility preferably is achieved without having to remove or detach the cargo carrier assembly once the cargo carrier assembly is in position relative to a supporting device as in a wheeled vehicle. In a preferred embodiment there is provided an adaptor that enables the cargo carrier assembly to continue functioning as a cargo carrier while also providing a stable platform for attachment of another component or article as in a bike rack or grill assembly (e.g., a grill with an extension such as a support post designed for adaptor connection). Further the adaptor is also preferably designed for a rapid switching out amongst various “additional components” such as a removal of one (e.g., a grill assembly) and replacement with another additional component (e.g., a bike rack) and preferably with storage of one or both on the cargo carrier (e.g., a camping trip where the additional component first positioned during vehicle travel to a desired location is the bike rack and then, upon arrival, a grill assembly stored on the cargo rack during travel to the location is switched out with the bike rack). Thus, items that are to be attached to the connection end of the adaptor can be stored on the cargo carrier platform prior to and/or after mounting on the adaptor. Storage of additional components can also be together with other cargo items as in a grill assembly to be attached to the cargo carrier adaptor of the present invention placed on one section of the cargo platform while a cooler or other item (and/or an additional component to be releasably joined with the adaptor) is stored on an opposite or different section of the platform.

Also, the one or more articles to be attached to the cargo carrier adaptor are preferably joined by way of an adaptor that is preferably an independent article securable and releasable relative to the cargo carrier and which receives (e.g., connects with) in releasable fashion (e.g., tool-less or single tool connection) an additional component assembly such as a grill assembly or bike rack assembly with extension post. The connection of an additional component with the adaptor is preferably achieved with joining means as in an extension device extending from the additional component and suited for reception within a joiner (e.g., a receiving portion) of the adaptor while the adaptor is supported by the cargo carrier (preferably by way of a releasable connection with the cargo carrier). The adaptor is preferably an independent component relative to the cargo carrier assembly as well as relative to the additional component assembly, although the present invention includes alternate arrangements wherein the adaptor is integrated with the additional component assembly or the cargo carrier platform. However, the preferred embodiment features an adaptor that is releasably attachable to both the cargo carrier and to the additional component assembly.

Also, the cargo carrier adaptor of the present invention preferably relies on the receiver bar for support while the receiver bar also provides for cargo carrier platform support. For example, an arrangement wherein a single receiver bar provides vehicle-to-cargo carrier platform support (whether a unitary cargo platform or a cargo platform having sections that can be broken down as described for FIGS. 1 and 2) and adaptor support. The adaptor is preferably supported by the cargo carrier assembly directly and to the vehicle indirectly via the intermediate cargo carrier assembly. In this way the adaptor, while supported by the cargo carrier assembly, functions to provide a joining location for an additional component assembly such as one comprising an additional component (e.g., bike rack or grill assembly) and an extension (e.g., an independent or integrated support post). The joining location is preferably spaced to the exterior of the cargo carrier such that the extension post supporting the additional component can extend to the exterior of the cargo platform for easy access while the cargo platform remains hitched.

### BRIEF DESCRIPTION

FIG. 1 shows a perspective view of a prior art, assembled cargo carrier;

FIG. 2 shows an exploded view of the prior art cargo carrier in FIG. 1.

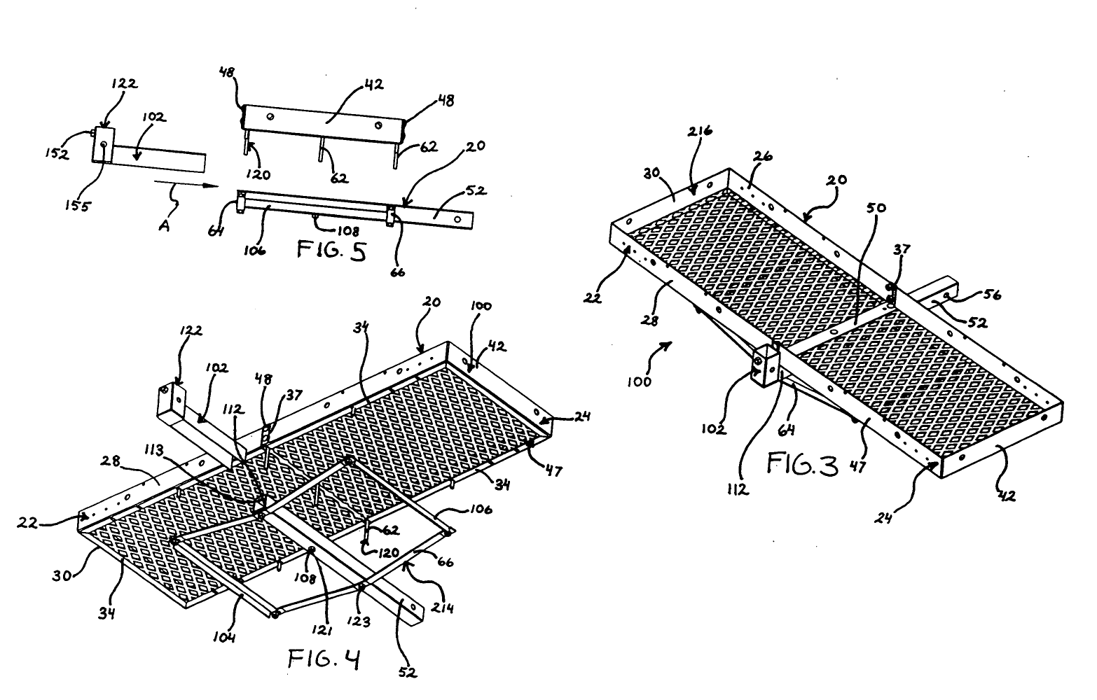

FIG. 3 shows a perspective view of the cargo carrier assembly of the present inventive subject matter;

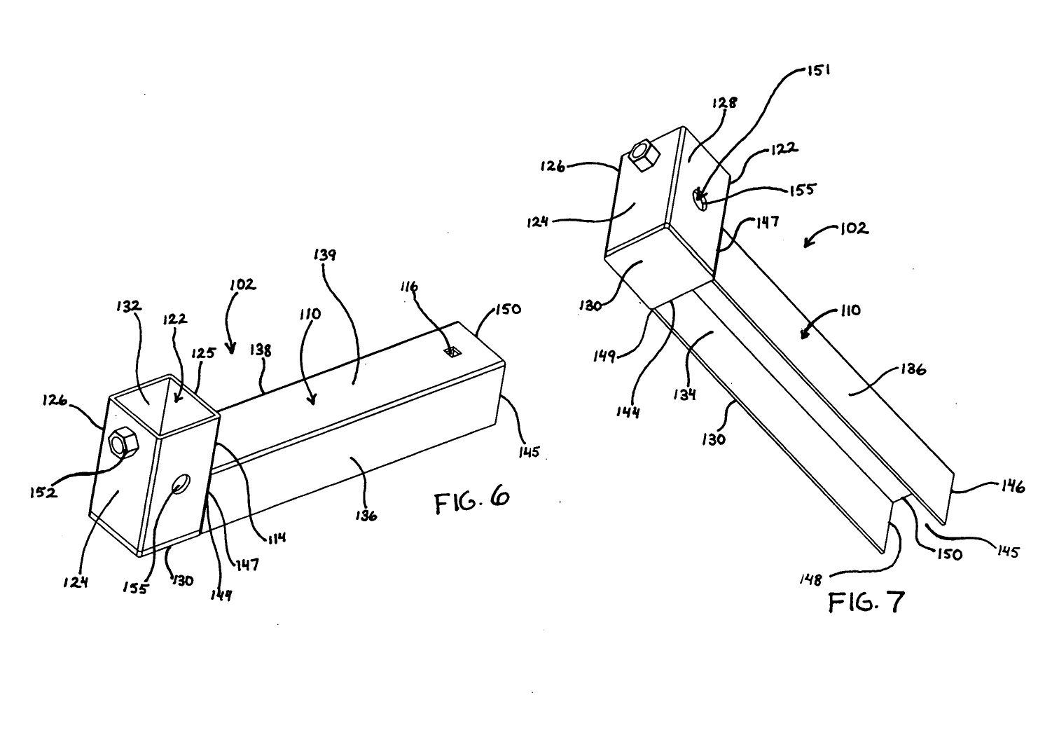

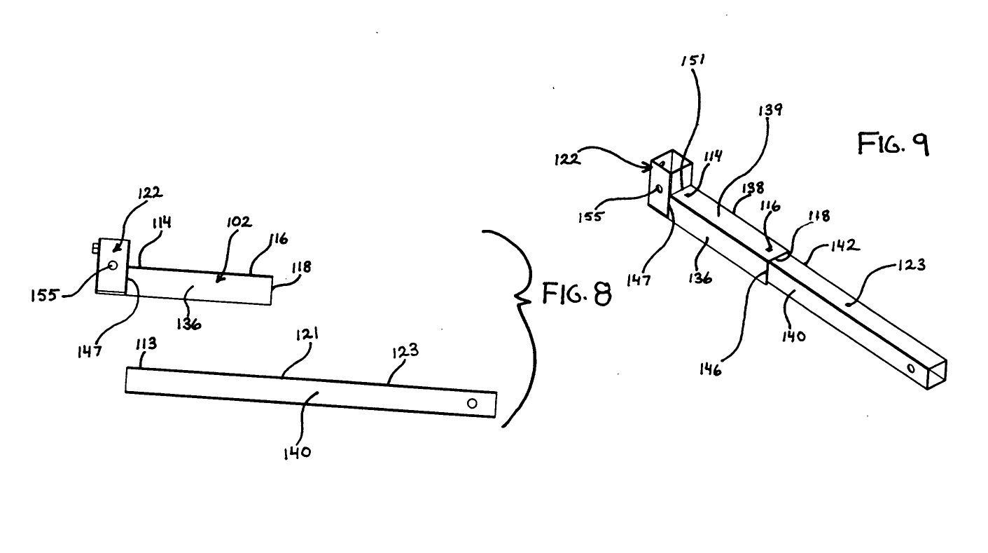

FIG. 4 shows an exploded, from underneath, view of that which is shown in FIG. 3.

FIG. 5 shows a side view of the exploded view in FIG. 4.

FIG. 6 shows a top perspective view of an embodiment of an adaptor;

FIG. 7 shows a perspective, from underneath, view of that which is shown in FIG. 6.

FIG. 8 shows an exploded view of a pre-install or post-install relationship between the adaptor of FIG. 7 and the receiver bar of the cargo carrier.

FIG. 9 shows the adaptor of FIG. 8 received by the receiver bar's free end region.

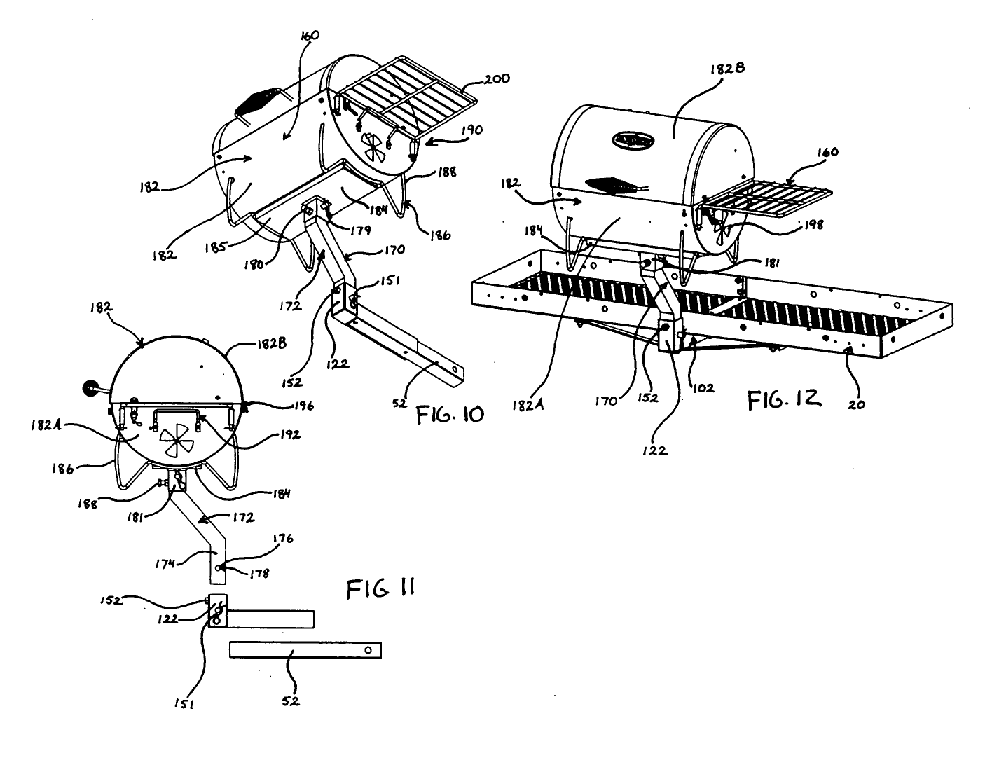

FIG. 10 shows the adaptor and receiver bar assembly shown in FIG. 9 with a connected additional component assembly, which is in the form of a grill assembly with independent multi-bend extension post.

FIG. 11 shows an exploded view of that which is shown in FIG. 10.

FIG. 12 shows a cargo carrier assembly system of the present invention with an additional component in the form of a grill assembly.

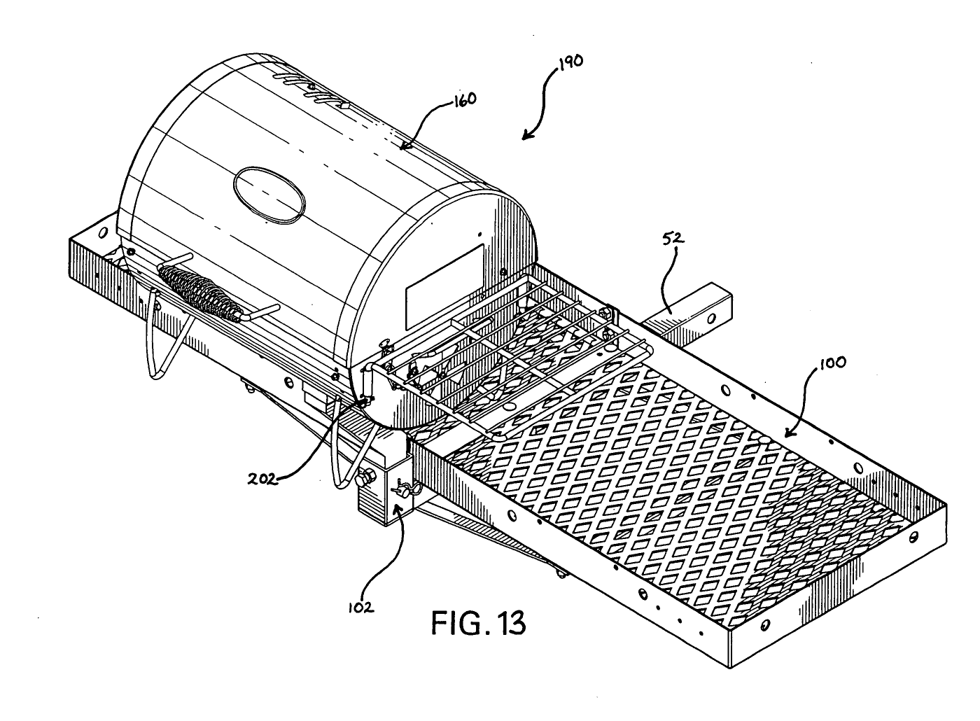

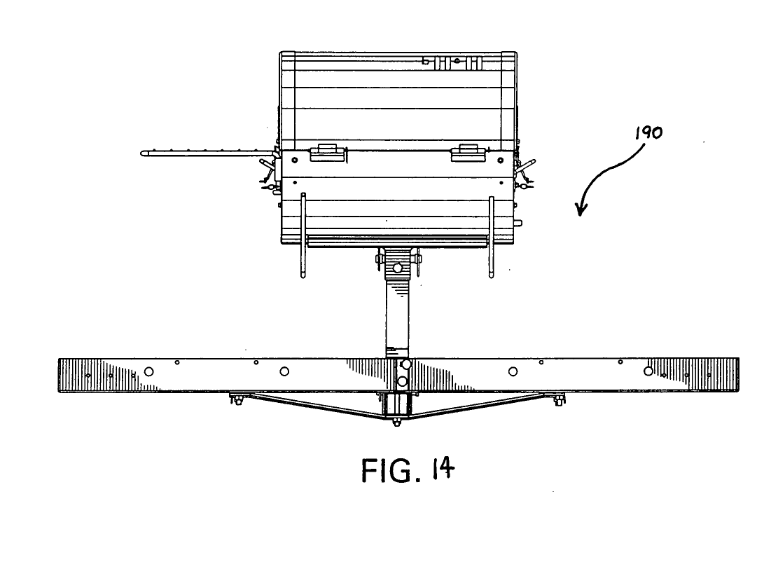

FIG. 13 shows the cargo carrier assembly system of FIG. 12 from a different perspective angle.

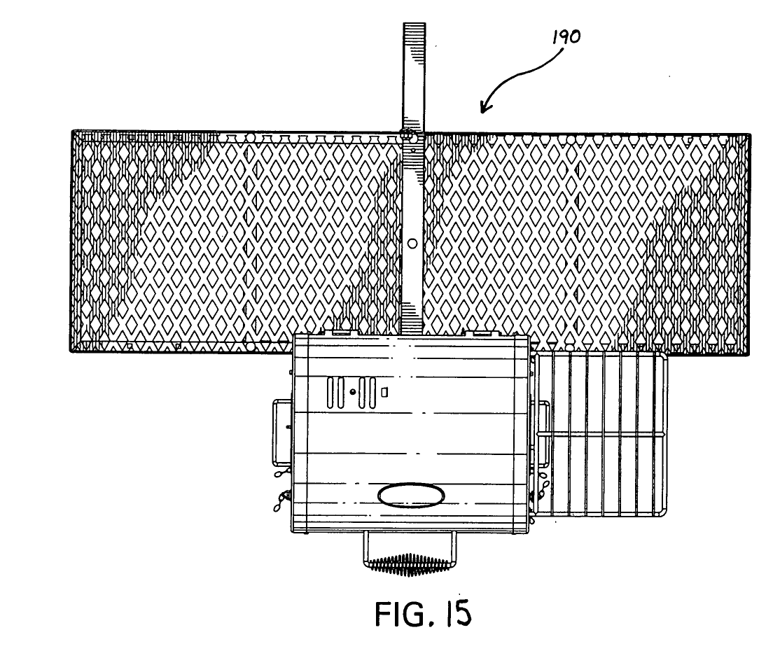

FIG. 14 shows a rear elevational view of the cargo carrier assembly system of FIG. 13.

FIG. 15 shows a top plan view of the cargo carrier assembly system of FIG. 13.

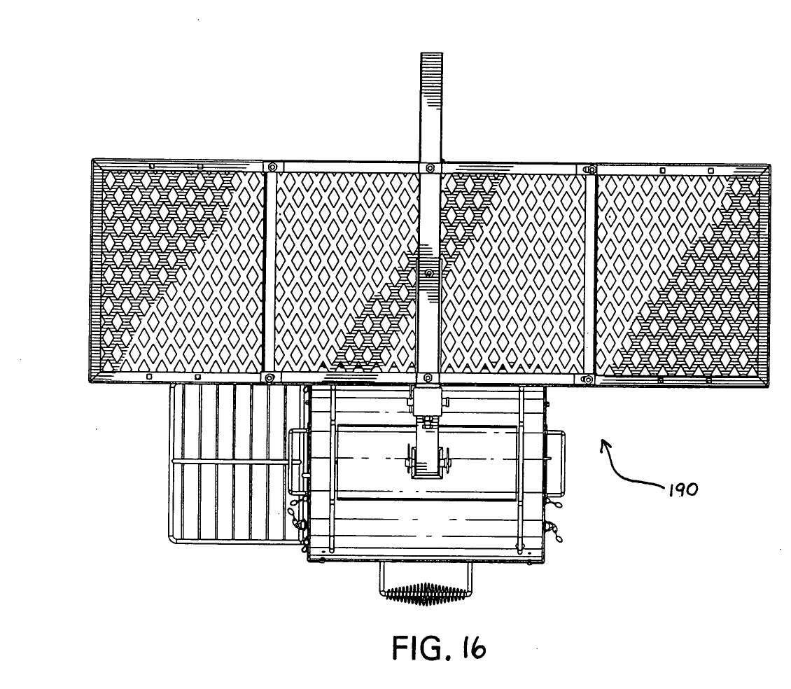

FIG. 16 shows a bottom plan view of the cargo carrier assembly system of FIG. 13.

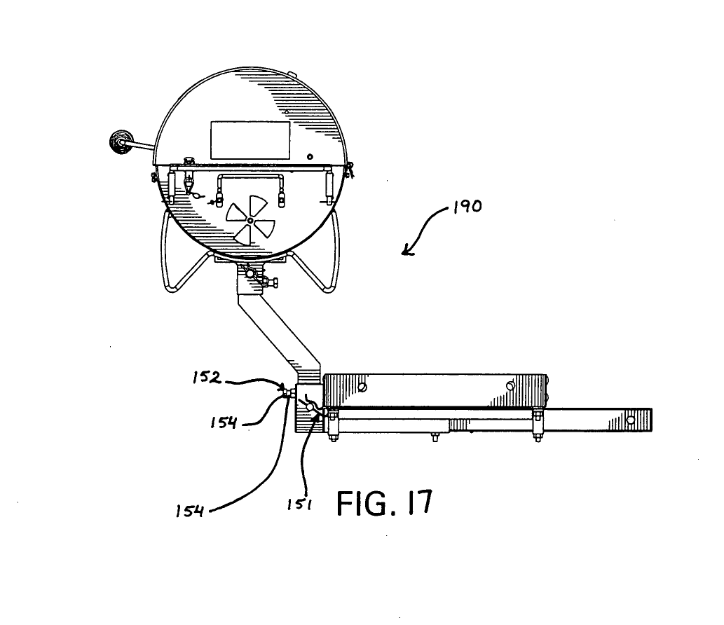

FIG. 17 shows a left side elevational view of the cargo carrier assembly system of FIG. 13.

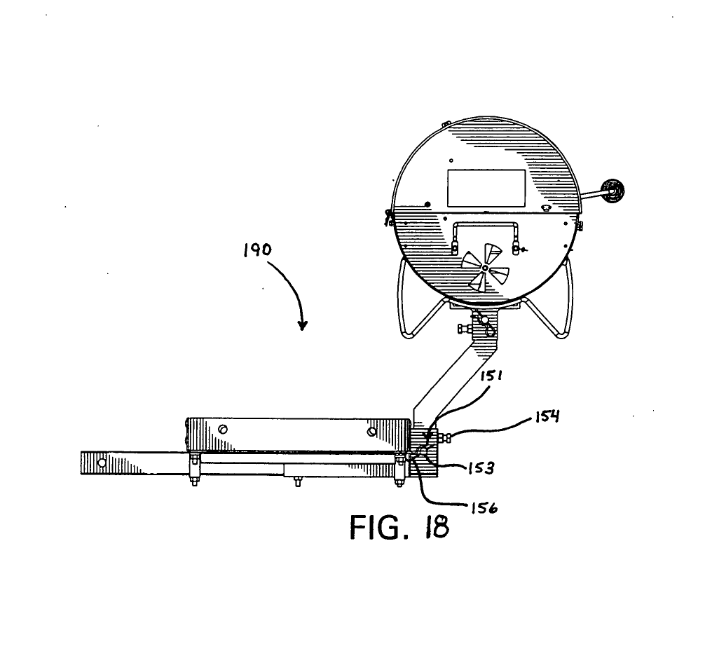

FIG. 18 shows a right side elevational view of the cargo carrier assembly system of FIG. 13.

FIG. 19 shows the adaptor and receiver bar assembly of FIG. 9 with added additional component assembly in the form of a bike rack and independent straight post extension.

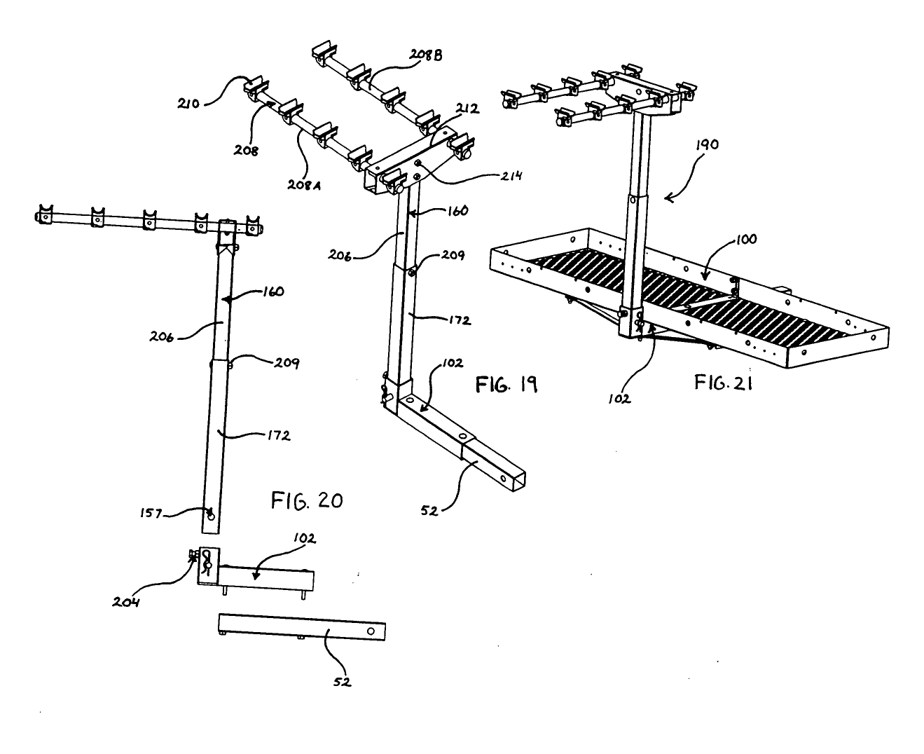

FIG. 20 shows the assembly of FIG. 19 in an exploded view.

FIG. 21 shows a cargo carrier assembly system of the present invention with the additional component being a bike rack.

### DETAILED DESCRIPTION

Prior art FIGS. 1 and 2 are described above in the background portion of the present application.

FIG. 3 shows a perspective view of an embodiment of the cargo carrier assembly of the present inventive subject matter, while FIG. 4 shows an exploded, from underneath, view of that which is shown in FIG. 3. The illustrated cargo carrier assembly embodiment 100 of the present invention is shown as being an enhancement of the above described cargo carrier 20, although the subject matter of the present invention is also well suited for other cargo carrier designs (including a monolithic cargo platform as compared to the two platform section illustrated) with appropriate revisions falling within the scope and spirit of the present application's disclosure.

To facilitate the discussion below, common components between the FIG. 1 cargo carrier 20 and the cargo carrier assembly 100 of the present invention have been referenced the same. Thus, as seen in FIGS. 3 and 4, an embodiment of cargo carrier assembly 100 comprises a modified cargo carrier 20′ (with modified cargo platform assembly 47′ and receiver bar 52) in combination with adaptor 102. The cargo platform assembly 47′ is modified relative to the above described platform 47 with the modification including added struts 104 and 106 extending parallel with the receiver bar 52 and secured by securement means (e.g. bolts) to the respective free ends of the bridge supports 64 and 66. Struts 104 and 106 are shown extending underneath respective mesh sheets 36 and 46 in an intermediate area thereof and sufficiently close to the undersurface of the sheets 36 and 46 to provide underlying support contact upon a sufficient load being placed on the sheets 36 and 46 (alternatively they can be clip attached or attached directly by some alternate attachment means to the cargo support surface shown in a preferred embodiment as being mesh sheeting). In the embodiment shown struts 104 and 106 are shown as right-angle bars for added rigidity as they extend across between the interior and exterior flange supports 34 supporting the sheets 36 and 46. FIG. 4 further illustrates welded on nuts 108 provided on the underside of receive bar 52 to correspond with bolts 62 (three preferred such as to provide for front, back and intermediate bolt securement means in the modified cargo platform assembly 47′).

With reference to FIGS. 6 and 7 there is shown adaptor 102 alone. As seen, adaptor 102 includes receiver bar connector 110 or receiver bar connection means 110, which in a preferred embodiment comprises a C-shaped cross-sectioned sleeve that is preferably designed for a conformance fit (slight friction contact or a minimum slide clearance as in less that a summed ½ inch respective side-to-side slide action between the connector 110 and the free end region 112 of the receiver bar 52 and more preferably less than an ⅛ inch summed clearance between the two). As best shown in FIG. 9, connector 110 preferably includes two securement locations shown in the form of bolt holes 114 and 116 designed for receipt of two bolts 62 (FIG. 5) or fastening means 62. In a preferred embodiment the connector sleeve 110 is of a length that is sufficient to extend the sleeve over two bolt holes formed in receiver bar 52 as in the sleeve having a free edge 118 (FIGS. 8 and 9) that is positioned just past intermediate bolt hole location 121 after being slid in position (e.g., connector 110 preferably extends for 10 to 60% and more preferably about 15 to 45% as in about 40% of the full length of the receiver bar 52 or alternate vehicle interfacing means). In this way the exterior bolt hole 114 can be aligned with the bolt hole 113 formed at the free end region 112 of receiver bar 52 and the interior bolt hole 116 can be aligned with bolt hole 121 such that two bolts 62 can be used to provide securing means 120 between the adaptor's connector 110 and the receiver bar 52. That is, in the embodiment shown, the matching pairs of apertures in the receiver bar and the connector (113, 114 and 116, 121) are aligned by way of the sleeve/joiner and receiver bar contact relationship to enable respective bolts 62 to extend therein. Other securement means 120 are also featured under the present invention with the preference being having the securement means having releasable engagement means as in the bolts shown or alternate releasable engagement devices such as pins with clips, cam lock assemblies, key and slot combinations, over-center toggle latches, etc.

The securement means 120 also preferably functions to secure the cargo platform in position relative to the receiver bar as in the illustrated clamping down of tie plate 50 with three of bolts 62. In addition, as shown in FIG. 4 the securement means 120 also preferably works toward fixing in place bridge supports 64 and 66 by having the non-intermediate, two bolts 62 extend through both holes provided in the central region of bridge supports 64 and 66. Thus, in the illustrated embodiment preferably at least one bolt or fastening device of the securement means extends through the tie plate 50, or the cargo platform itself if no tie plate featured (and thus past the level of the cargo platform), the connector 110, the receiver bar 52 and one of the bridge supports, while at least two bolts 62 of securement means 120 preferably extend through the tie plate 50 (or the cargo carrier platform itself if a non-tie plate arrangement is utilized for the cargo carrier platform), the connector 110 and the receiver bar. In addition the securement means 120 preferably includes at least one bolt that extends through the tie plate (or the cargo carrier platform itself if a non-tie plate arrangement is utilized for the cargo carrier platform) and through the receiver bar and into one of the two bridge supports 64 and 66. In this latter embodiment described the connector 110 is preferably of a length that does not extend entirely between the front and rear edge of the cargo carrier platform such that the most interior bolt 62 of the securement means does not pass through the connector 110 in passing through the exposed interior bolt hole 123 used in securing the cargo carrier platform to the receiver bar.

With reference again to FIGS. 6 and 7 there is seen that adaptor 102 further comprises joiner device or joining means 122. In the illustrated embodiment joiner device 122 is a female joining device functioning as a receiver for the additional component assembly as in a tubular member such as a cup-shaped member with the receiver further preferably having a polygonal cross-section as in the four sided arrangement shown with exterior wall 124, interior wall 125, opposing side walls 126, 128, and bottom wall 130 which together define a reception cavity 132. A fully closed bottom wall is preferred to provide a vertical insertion stop means, although alternate arrangements are featured under the present invention for the lower portion of receiver 122 as in a partially closed off bottom (inward flange or inward projections) for providing stop means or an opened bottom tubular member with or without independent stop projections (e.g., in a alternate embodiment the additional component being inserted into or about the receiver can provide the vertical stop function. In other words, rather than the joining means 122 being a female component receiving the male projection of the additional component assembly (described below), the joining means can comprise a male projection and the additional component assembly can provide the female component of the joined combination or the joiner may form part of a dual male/female joint arrangement as in concentric rings with telescopic ringed groove reception for one or the other of the receiver or additional component assembly being joined together).

As shown in FIG. 6, reception cavity 132 is preferably a smooth sided cavity (e.g., all sides and total wall length for each wall) such that an extension device (of the additional component assembly) in the form of a support post or the like can be readily inserted into cavity 132 until coming into abutment with the bottom wall 130. Further, as best seen in FIG. 7, the C-shaped connector 110 is arranged such that the receiver bar capture opening 134 of the connector 110 is down facing and has an access plane at essentially the same level as bottom wall 130 when the adaptor is placed on the receiver bar. The illustrated adaptor connector 110 is shown with closed top wall 139 (within which is shown formed the holes 114 and 116 with holes 114 and 116 preferably having a square profile to enable a square cross-section bolt head portion to extend thereinto for rotation preclusion with or without an additional one formed in tie plate 52, if so utilized—as by an extended square head extension in the bolt before threads initiate).

Connector 110 is further shown with side walls 136 and 138 which are spaced apart for just a little bit more than the width of the receiver bar so that the side walls 136 and 138 generally preclude any significant side-to-side adjustment between the connector 110 and receiver bar 52 once the connector is slid or dropped in position (e.g., a sliding friction relationship or less than a ½ inch total clearance, and more preferably less than a ⅛ inch clearance (including a slide fit of essentially zero clearance) between the interior of side walls 136 and 138 and the internally received receiver bar's exterior side walls 140 and 142 (FIG. 9) is preferred).

FIG. 7 further illustrates connector 110 being an open ended sleeve at both ends prior to securement (e.g., a rigid weld securement) with receiver 112. In this way, exterior open end 144 (defined by the exterior end edges (147 and 149) of walls 136 and 138 and the exterior edge 151 (FIG. 9) of upper wall 139 can be directly welded to the lower half region of the interior wall 125 of joiner 122. A permanent connection provided by a weld is preferred although other connection means including releasable connection means as in bolted flange sets are also featured under the present invention as well as a monolithic formed unitary adaptor alternative. The corresponding opposite connector free end 145 is shown in FIG. 7 as being defined by side wall edges 146 and 148 and upper wall edge 150 (together forming free edge 118). The end 145 remains open and thus provides for either a drop down and/or slide on arrangement relative to the free end of receiver bar 52. A ready for drop down in position arrangement is illustrated by FIG. 8 and a completed drop down in position relationship is shown in FIG. 9 between the receiver bar 52 and the adaptor 102 of the present invention. FIG. 5 illustrates a combination drop down and side on starting relationship between the adaptor 102 and the receiver bar 52. The closed off open end of sleeve 110 provided by rear wall 125 of joiner 122 functions as a quick alignment means as once the connector is slid and/or dropped into position the abutment of rear wall 125 with the free end 112 of receiver bar 52 results in the alignment of the securement means 120 as in the alignment of the bolt hole pairs 113, 114 and 116, 121 such that the bolts can be readily inserted into position without much, if any, further position manipulation by the assembler.

As further shown in FIGS. 6 and 7 receiver 122 of adaptor 102 is preferably of a height greater than a side wall (136, 138) of the sleeve 110 as in a 1.5 to 4/1 height differential with a 2/1 height ratio being preferred. As seen in FIG. 3 the preferred 2/1 height differential places the receiver opening 132 essentially commensurate with an upper edge of wall 28 and wall 40 defining the cargo carrier platform sections 22 and 24 as in having the upper edge of rear wall 125 at the same height as the upper edge of at least one of walls 28 and 40 or within 2 inches thereof (plus or minus). Also as shown in FIGS. 6 and 7 a receiver locking device 151 is featured with a preferred embodiment being a corresponding through-hole pair set comprising aligned holes (153 of FIGS. 18 and 155) in side walls 126 and 128 of receiver 122 and a corresponding pair (157 in FIG. 20) in the additional component though which a suitable attachment device (156, FIG. 18) as in a pin with clip combination inserted following insertion of an additional component's receiver shaft into the receiver cavity 132 as explained in greater detail below. As seen, the through-hole pair set is preferably centralized in the respective side walls 126 and 128 and also parallel with the through holes (e.g., 56) for the inserted end of receiver bar 52.

FIGS. 6 and 7 further illustrate joiner 122 having stabilizer 152 which in a preferred embodiment is a threaded aperture for receiving a stabilizing insert (e.g., bolt 154 shown in FIG. 10). The threaded aperture is shown in FIGS. 6 and 7 as being provided by an integrated nut which is preferably permanently secured (e.g., welded) to align with a corresponding hole (not shown) formed in exterior wall 124 of joiner 122. As explained in greater detail below a stabilizer insert as in a bolt can be threaded in the threaded aperture of stabilizer 152 such that the free end of the bolt compresses in position the inserted extension of the additional component received within joiner 122 and/or a corresponding threaded aperture can be relied upon in the inserted additional component for a combination attachment device (pin with clip) and the above noted threaded stabilizer can be relied upon. The subject matter of the present invention features the use of both an attachment device at one inserted location or level for the additional component assembly (as in the below described support shaft of grill assembly 160 shown in FIGS. 10 to 12) in combination with the stabilizer with stabilizer insert, preferably at a different level relative to the attachment device and preferably at a different orientation relative to the attachment device. For example, in a preferred embodiment the stabilizer insert has a central axis parallel to the direction of elongation of the receiver bar and the attachment device extends transverse to the direction of elongation as in parallel to the receiver hitch's pin extension. Various other arrangements are also featured under the present invention as in reversing the relative position of the attachment device and stabilizer means described above or using only one of the two as in only the described attachment device or only a stabilizer means. Also, while the adaptor is described above as having a receiver with a cavity extending along a vertical axis, alternate connection means are featured under the present invention as in, for example, a sleeve connector with a receiver cavity extending along the same axis as the receiver bar (e.g., a horizontal axis for the joiner's receiving cavity and a corresponding shaped insertion extension shaft or bent post for the additional component assembly). However, the arrangement with the joiner (preferred receiver defining a cavity form) 122 having a vertical axis is preferred.

In addition to the above described cargo carrier assembly 100 (comprising cargo carrier platform assembly 47'and adaptor 102 combination), the present invention also features a cargo carrier system as in system 170 shown in FIG. 10 to 12 comprising a cargo carrier assembly 100 as well as extension device 172 (which in a preferred embodiment is an extension bar designed for engagement with the adaptor's joiner 122 at one end and to a reception region of an additional component such as a reception region formed as part of a grill assembly) In a preferred embodiment the extension device 172 is preferably an independent member as in a single or multi-bend tube or bar structure having opposite free ends designed for releasable engagement with a respective one of the adaptor and the additional component (e.g., an additional component in the form of a bike rack or grill assembly). However, the present invention also features a system 170 wherein the extension is an integrated part (e.g., a non-releasable welded arrangement) of either the additional component or the adaptor 102. For example, extension 172 can be a monolithic extension off from connector sleeve of adaptor 102 replacing the joiner 122 (and hence the attachment device and stabilizer would not be needed at that interface) having an upper end for securement to a receiving area of an additional component 160 which in FIGS. 10 to 18 is represented by grill assembly 160. Alternatively, the extension device can by an integrated part of the additional component (still forming an additional component assembly) designed for insertion into the joiner 122 of the adaptor 102 as described above.

With reference to FIG. 11 there is seen an unassembled illustration of the adaptor 102 relative to both the receiver bar 52 and the extension device 172 (shown in a preferred two bend and essentially z-shaped configuration or one that moves the connection location to the additional component farther away from the vehicle). Extension device 172 is shown as having a lower insertion end 174 with an attachment aperture 176 which in the illustrated embodiment is a through-hole set up 178 for receipt of pin and clip attachment device combination 151 and designed to provide for engagement of extension device 172 with joiner 122. The preferred pin and clip combination for attachment device 151 is shown connecting the telescoping bottom end of extension device 172 within joiner 122 of adaptor by way of a through-hole arrangement in the bottom end of extension device 172, which aligns with the through-hole pair in joiner 122 once extension device 172 is properly inserted into joiner 122. Relative to this arrangement, the extension device 172 can be inserted and locked into a secured state followed by attachment of the additional component such as grill assembly 160 at the upper free end or the additional component can be locked in place or positioned first to the extension device followed by the joining of extension device 172 with joiner 122.

FIG. 11 illustrates the state where the extension 172 has been inserted into the joiner 122 and the extension is fixed in position both with the above described pin and clip combination 151 as well as stabilizer 152 (preferably a combination of stabilizer nut 157 and stabilizer bolt 154 or some alternate stabilizing means). In FIGS. 10-12 there is shown stabilizer bolt 154 not yet inserted into stabilizer nut 153 and a corresponding hole in receiver wall 124, although such an arrangement can be seen in FIG. 17 for a different embodiment of the present invention.

As seen from FIGS. 10-12 grill assembly 160 is representing an example of the above referenced “additional component” to be supported by the receiver bar 52 preferably in combination with the cargo carrier. Grill assembly 160 comprises receiving device 181 (which can be a male and/or female shaped member with the combination being in a receiving relationship) that preferably comprises an open ended tubular extension or cup shaped member extending from base 184 secured to the underside of main housing 186 of grill assembly 160. As examples of alternate embodiments for receiving device 181 (or receiving means), there is featured a grill body projection (not shown) for telescopic insertion into a female receiving portion provided by extension 172 (e.g., an open end thereof) or the female reception area can be provided internally of the main body 186 of the grill assembly 160 as in a cup shaped member extending upward rather than downward as represented by projection 181 in FIGS. 10 to 12.

As further shown in FIGS. 10 to 12 the receiving device 181 preferably also has attachment device 179 and/or stabilizer 180 with an embodiment of attachment device 179 shown as comprising a pin and clip combination extending through opposing side walls of the upper inserted end of extension 172 (preferably the joiner 122 and receiving device 181 have a mirror image relationship such that the same side walls feature the attachment device and the exterior exposed wall has the illustrated added stabilizing device 180). Also the stabilizing devices 180 and 152 are preferably arranged to be vertically interior relative to the attachment or locking devices 151 and 179 that are preferably arranged to be vertically exterior relative to the stabilizing devices as seen in FIG. 10. This results in the attachment device 179 being closer to the grill body base 184 than stabilizer 180 and attachment device 151 being farther from the grill body base 184 than stabilizer 152.

In FIGS. 10 to 12, the combination of cargo carrier system 170 and additional component (grill assembly 160 in this embodiment) provides cargo carrier system assembly 190. As made clearer below cargo carrier system assembly 190 can also take on a variety of forms as by connection of different additional components (e.g., swapping out a grill assembly for a bike carrier). In the present application the term “cargo apparatus” is designed to be a generic reference to the various cargo device combinations featured herein.

FIGS. 10 to 12 further illustrate a preferred embodiment of the grill body base 184 for grill assembly 160 which has means for providing a higher strength region 185 (e.g. a thickened section integrally formed in the grill body 182 or an added plate and/or a section of higher strength material as compared to the adjacent grill body). A preferred embodiment is an added plate of material secured to the grill body and having a common shape relative to the region of grill body attachment. For example, in FIGS. 10 to 12 grill body 182 is shown as having a generally cylindrical shape with capped opposite ends (although alternate grill body shapes are featured under the subject matter of the present invention as in a rectangular shape or a specialized shape such as a football helmet shape) and the grill plate 185 is shown with a concave shape conforming to the bottom curvature of the grill body. Grill assembly 160 is also shown as having additional component stand alone support means 186 such as the illustrated legs 187 and 188 positioned to opposite sides of receiving device 181. In a preferred embodiment legs 187 and 188 extend away from grill body 182 a greater extent than does receiving device 181 and less than the length of adaptor extension 172. Alternate embodiments for support means 186 include a more pedestal like stand as in one comprised of a flanged or projection extension(s) (not shown) extending around and/or out from the free end of attachment device 181 (alone or in combination with separate support means such as the noted legs 187 and 188).

FIGS. 10 to 12 additionally show additional grill assembly components as in grill handling means 192 shown in the form of grasp handles 192A and 192B. The grill handling means provides for easy positioning of the grill assembly 160 relative to extension device 172 and/or relative to joiner 122 if extension device 172 is secured to grill assembly 160 before connection with joiner 122 (or an integral component of grill assembly 160). Grill body 182 is further shown as being a two body section assembly featuring bottom section 182A for receiving the cooking grill and, in some embodiments (e.g., non-gas) fuel such as charcoal briquettes or in an alternate embodiment a gas or electrical source can be used for heating as in a fuel (e.g. propane tank) connection (not shown) or a generator plug-in arrangement (not shown) (which generator and/or fuel tank can be transported on the cargo carrier together with the grill body. Connected to bottom section 182A is top section 182B which preferably is secured for rotation as in the illustrated hinge connection 196. Further illustrated in FIGS. 10 to 12 is adjustable venting assemblies 198, 199 in bottom 182A and top section 182B, respectively, as well as a releasable side-rack 200 (a slide support and pin retention means 202 as illustrated in FIG. 13).

FIGS. 13 to 18 illustrate the cargo carrier assembly system 190 in greater detail and from a variety of angles to more clearly illustrate the features described above relative to FIGS. 10 to 12.

FIGS. 19 to 21 illustrate an alternate embodiment of the cargo carrier assembly system of the present invention as represented by reference 190′. In FIGS. 19 to 121 like components relative to the earlier described embodiments are represented by a common reference number. As seen from FIGS. 19 to 21 rather than the additional component 160′ being a grill assembly there is featured a bike rack assembly 160′. For the illustrated embodiment there is featured an independent extension device 172′ having a similar connection means 204 to connect extension 172′ to joiner 122 of adaptor 102. Further, bike rack assembly 160′ is shown as having a connector shaft 206 designed for telescopic connection with extension device 172′ (extension device 172′ is shown as a straight section rather than a multi-bend extension section as in the earlier described extension embodiment 172, although a bike rack can also be supported on a bent in or out extension device). Also, rather than a multi connection arrangement (e.g. stabilizer and pin/clip combination) with transverse axes as represented by connection means 204 there is featured under the illustrated embodiment a single bolt and matching throughole connection arrangement 209 for the illustrated telescopic connection between extension device 172′ and shaft 206 of bike rack assembly 160′.

FIGS. 19 to 21 also illustrate cantilevered and parallel bike rack post supports 208A and 208B providing cantilevered bike support means 208. There is further featured a plurality of bike reception pads 210 on each and cantilever base support 212. Thus bikes can be readily inserted into matching, respective pads 210 and held in position with lock down straps or the like (not shown). Cantilever base support 212 is shown as being secured to an upper end of shaft 206 as in the illustrated bolt securement assembly 214 or through a more permanent connection as in a weld.

The grill assembly 160 and bike rack assembly 160′ provide examples of the additional component and are but a few of the possible examples with other non-limiting examples being containers (e.g. luggage or higher height level cargo holders) or supplemental to roof support elements for supporting elongated elements such as planks (wood or vinyl), ladders or kayak supporters.

The present invention also includes a method of assembling a cargo carrier apparatus an in a method for assembly of a system such as systems 190 and 190′ or any sub-set thereof. For example, with reference to FIGS. 3 to 9, the assembly process involves, for example:

providing receiver bar 52;

providing an overlying (preferably at least a part thereof being overlying relative to receiver bar 52) cargo platform 216 (FIG. 3) providing means to support cargo placed thereon preferably with an additional feature of some degree of cargo side slide retention as in vertical height cargo platform side walls or a cage-like bar assembly;

providing an underlying (preferably at least a part thereof being underlying relative to receiver bar 52) an added cargo support device 214 (FIG. 14), which in a preferred embodiment features bridge support(s) (e.g. 64, 66) and/or support strut(s) (e.g., 104, 106) preferably assembled into a common assembly prior to securement to the receiver bar 52 as in by a bolt arrangement;

providing an adaptor with a preferred embodiment being an adaptor designed for support by a free end of a cantilevered receiver bar extending out from a support region of a vehicle as in a hitch support region of a vehicle (a preferred support relationship being one with a sleeve or partial sleeve as in a C-sleeve with a downward located opening and above cover for covering, the upper surface of the free end region of the adaptor and two side wall sections; and

interconnecting the above noted receiver bar, overlying cargo platform and adaptor as well as preferably the underlying cargo support platform device, if utilized. A preferred interconnecting procedure involves a common securement member as in an elongated bolt connecting multiple ones of the above noted receiver bar, overlying cargo platform and adaptor as well as preferably the underlying cargo support platform device, if utilized, set of components. As an example, a bolt or bolt set or other (preferably releasable with or without tool assistance) securement means for connecting an overlying cargo carrier and adaptor and receiver bar in a stack arrangement. With a preferred embodiment featuring a securement means also interconnecting the bridge support to the joiner (or a sub-combination thereof such as a securement arrangement which includes securement means connecting the underlying cargo support device to the receiver bar and overlying cargo platform exclusive of the adaptor, or any one of a variety of sub-sets of multiple connection arrangement in said bolt(s) or alternate types of securement means).

Also, the interconnection described above can also include an assembly of a break-downable cargo platform assembly as in one featuring multiple cargo carrier platform sections and/or an added sandwiching tie plate for connecting the cargo carrier platform sections together preferably through connection to the receiver bar (with the adaptor also preferably included in that described stacking or sandwich arrangement).

The interconnecting cargo carrier assembly represented by the above noted interconnected receiver bar, overlying cargo platform and adaptor as well as preferably the underlying cargo support platform device, if utilized, set of components is then preferably connected to a vehicle or the like as by the above described vehicle hitch connection. In an alternate embodiment the below described added component with integral or independent extension is connected with the adaptor prior to securement of the receiver bar to the vehicle.

The assembly of a cargo carrier assembly system also preferably includes the connection of an additional component to the adaptor (preferably via an intermediate integral or independent extension device (e.g., 172, 172′) and preferably while the interconnected cargo carrier assembly 100 is assembled together and already supported by a vehicle). In a preferred embodiment the connection of an additional component to the adaptor is achieved via an independent extension device which includes an extension that is linear in one embodiment and one that is non-linear in an alternate embodiment as in a multi-bend post with there preferably being at least one bend extending out away from the vehicle supporting the receiver bar to place, for example, a grill body farther away from the supporting vehicle (e.g., automobiles, RV's, ATV's etc) or mounting means.

Preferably the connection of the extension device (or the additional component alone if the extension device is provided as an integral component of the adaptor) to the adaptor includes a multi-axes connection combination as in a bolt (e.g., compression against an exterior wall of a telescoping extension or through a hole in a wall of that telescoping extension) alone one axis and an attachment device (e.g., a pin and pin clip combination extending through matching through holes in walls of each of the adaptor and extension device) along a second axes, or one of the other only. Also in the situation where the extension device is an independent element, there is preferably provided a releasable connection relative to the additional component as in a similar multi-axes connection combination (preferably with common axes direction connectors being on a common side or sides of the extension both above and below and with one set of similar type and/or similar axis connectors being either internally above and below relative to the other set or vice versa).

In a preferred embodiment the extension device is inserted into the adaptor and a pin connection is arranged in similar fashion to a preferred hitch pin connection with a vehicle at the opposite end of the receiver bar and a threaded bolt arrangement with the bolt axis extending transverse to the attachment pin axis of elongation. A similar connection combination is preferably provided at the opposite end of the extension relative to the additional component to be secured in a desired position.

In one embodiment of the present invention the assembly of cargo carrier assembly system further includes the securement of a grill assembly to the extension as the step of securing an additional component. The grill assembly (e.g., 160) is preferably modified from a standard grill assembly to provide for the environment of being part of a cargo carrier assembly system supported and moved along together with a vehicle. An example of such a modification includes strengthening the region where the connecting portion of the grill assembly is joined with the remainder of the cargo carrier assembly system as in the noted extension (e.g., a telescopic connection).

In an alternate embodiment, the step of securing an additional component to the remainder of a cargo carrier assembly system as in securing to an extension of a cargo carrier adaptor 102 includes connecting a bike rack assembly (e.g., 160′) to an extension extending up from the adaptor and securing it in place as by way of a threaded bolt relative to a telescopic arrangement between a portion of the bike rack and the extension extending up from the adaptor.

While several embodiments of the invention have been shown and described, it will be apparent to those skilled in the art that modifications may be made therein without departing from the scope and spirit of the present invention.

What is claimed is:

1. A cargo carrier apparatus, comprising:
a cargo carrier platform;
a receiver device having a section adapted for support securement to a vehicle, and said cargo carrier platform being supported by said receiver device;
an adaptor supported by said receiver bar, and said adaptor having an additional component assembly joining device.

2. The apparatus of claim 1 wherein said adaptor includes a sleeve portion dimensioned for support receipt by a free end region of said receiver device.

3. The apparatus of claim 2 wherein said sleeve portion has a C-shaped cross-section with an upper section designed for support by an underlying positioned portion of said receiver device.

4. The apparatus of claim 3 wherein said sleeve portion extends for 45 to 45% of a full length of elongation of said receiver device.

5. The apparatus of claim 3 wherein said sleeve has one or more independent securement hole locations spaced along said sleeve for securement of the sleeve to said receiver device and said joining device being connected to said sleeve portion in a manner which provides an alignment facilitator relative to the one or more securement hole locations used in securement of said sleeve portion to said receiver device.

5. The apparatus of claim 3 wherein said receiver device is a receiver bar having means for securement to a hitch of a vehicle at an interior end and having a free end region at an opposite exterior end.

6. The apparatus of claim 5 wherein said adaptor comprises a sleeve portion supported by said free end of said receiver bar and said joining device extending from said sleeve portion and providing a female/male joining arrangement relative to an extension extending between the joining device and an additional component of the additional component assembly when the cargo carrier apparatus is in use.

7. The apparatus of claim 2 wherein said sleeve portion has a C-shaped cross-section and said joining device comprises a tubular member designed for a telescopic connection with an extension of the additional component assembly.

8. The apparatus of claim 1 wherein said receiver device is a hitch receiver bar and said adaptor has a sleeve portion connected to said joining device which is slideably received by the free end region of said receiver bar and said joining device being arranged, relative to an axis of elongation of said receiver bar, at a location farther removed from the vehicle than an adjacent section of said cargo platform.

9. The apparatus of claim 8 wherein said sleeve portion has an upper wall section, two opposite wall sections and a lower open region which provides for vertical movement of said sleeve relative to the free end region of the receiver bar during assembly.

10. The apparatus of claim 8 wherein said joining section includes a tubular member that has an axis of elongation arranged along said vertical and said tubular member extends vertically above a plane lying flush on an upper surface of said receiver bar.

11. The apparatus of claim 10 wherein said tubular member has a bottom wall section that at least partially closes off a bottom region of said tubular member.

12. The apparatus of claim 1 further comprising securement means for securing in position, in a stacked relationship at least two amongst said cargo carrier platform, receiver bar and adaptor.

13. The apparatus of claim 12 wherein said securement means includes a bolt extending through all three of said cargo carrier platform, receiver bar and adaptor.

14. The apparatus of claim 13 further comprising a cargo platform assembly comprising said cargo platform and an underlying bridge support structure and said securement means includes a bolt that extends through said cargo carrier platform, receiver bar, adaptor and said underlying bridge support.

15. The apparatus of claim 13 wherein said cargo platform is a break-downable cargo platform comprising a pair of cargo platform sections and a tie plate for joining adjacent edges of said cargo platform sections and said bolt extends through said tie plate of said cargo carrier platform.

16. The apparatus of claim 1 further comprising an extension device and an additional component and said extension device being releasably joined with said joining device and extending between said joining device and said additional component.

17. The apparatus of claim 16 wherein said additional component is fastened to said joining device with an attachment device comprising a pin and clip combination.

18. The apparatus of claim 16 wherein said additional component is a grill assembly comprising a grill body and an extension reception device supported by said grill body and at least one stand alone leg support designed to support the grill body when said grill assembly is moved from a support relationship with said adaptor.

19. The apparatus of claim 18 wherein said reception device is supported on a strengthened section of said grill body which is integrated with a grill body of said grill assembly.

20. The apparatus of claim 18 wherein said reception device is a pocket member which telescopically receives an upper end portion of said extension device.

21. The apparatus of claim 16 wherein said extension device includes a bent section that places an upper end of said extension device farther away from a supporting vehicle than a lower end of said extension device when in use.

22. The apparatus of claim 16 wherein said additional component is a bike rack assembly and said bike rack is connected to an upper end region of said extension device.

23. A cargo carrier adaptor device for connection of an additional component to a cargo carrier platform designed for vehicle support, said adaptor comprising a C-shaped cross-sectioned section adapted for support on a free end region of a hitch receiver bar supporting the cargo carrier platform and a component joining device extending from said sleeve portion and designed for a female/male connection arrangement relative to an extension device extending between the connection device and an additional component when the cargo carrier apparatus is in use.

24. A method of assembling a cargo carrier apparatus, comprising:
providing a receiver bar designed for cantilever attachment to a vehicle support location;
providing a cargo platform;
providing an adaptor having a receiver bar connection section dimensioned for support by a free end region of the receiver bar;
arranging the above noted receiver bar, cargo platform and adaptor in a stacked relationship.

25. The method of claim 24 further comprising providing an extension device and an additional component and joining the extension device to said adaptor with the additional component supported on a more upper region of said extension device located above the cargo platform.

26. The method of claim 25 wherein said additional component is a grill assembly and said method comprising releasably connecting said extension device and said grill assembly.

27. The method of claim 25 wherein said additional component is a bike rack assembly and said method comprising releasably connecting said extension device and said bike rack assembly.
